(19) United States
(12) Patent Application Publication
(10) Pub. No.: US 2020/0054531 A1
(43) Pub. Date: Feb. 20, 2020

(54) PILL COUNTING TRAY AND METHOD FOR USING SAME WITH MACHINE VISION

(71) Applicant: ILJ CORPORATION, NORTH CHESTERFIELD, VA (US)

(72) Inventors: JOHN MERRILL DAVIS, III, MIDLOTHIAN, VA (US); JANE DORNBUSCH DAVIS, MIDLOTHIAN, VA (US); MARK W. KITCHEN, HENRICO, VA (US)

(21) Appl. No.: 16/524,339

(22) Filed: Jul. 29, 2019

Related U.S. Application Data
(60) Provisional application No. 62/719,241, filed on Aug. 17, 2018.

(51) Int. Cl. A61J 7/02

(52) U.S. Cl. CPC A61J 7/02; A61J 2205/40; A61J 2200/70

(57) ABSTRACT

A tray and method for efficient counting of a desired number of pharmaceutical pills or capsules from a bulk supply and distributing said counted pills and any excess pills into a target container and the bulk supply respectively. The preferred embodiment of this invention incorporates a sprung, hinged flap which, when pressed into contact with the flat counting surface, forms a trapping enclosure for excess pills while the desired number of pills are poured with a novel funneling structure. Although useful by itself, the tray and method are designed for optimal time and motion efficiency and for accuracy when used with a machine-vision pill counter.

### CROSS-REFERENCE TO RELATED APPLICATIONS

This application claims priority to pending U.S. Provisional Application Ser. No. 62/719,241, filed Aug. 17, 2018, the contents of which are incorporated herein by reference in its entirety.

### FIELD OF THE INVENTION

This invention relates to devices and methods for counting pills, capsules, or the like ingested for medical purposes, and more specifically to a device and method for transferring a desired number pills or capsules from a bulk supply source into a target dispensing bottle in a retail pharmacy setting.

### BACKGROUND

Pill counting trays most commonly sold to and used by retail pharmacists today are variations of the device described in U.S. Pat. No. 2,530,009 for a “Tablet Counting Device.” The device comprises a low-walled, flat tray with a built-in pill capture trough. In operation, pills are swept into the trough by the operator using a spatula as they are manually counted. The curved capture trough and its curved hinged lid together form a storage funnel through which the counted pills eventually will be poured. The excess pills remaining on the tray surface are first restored to the bulk supply container, however, via a diametrically opposed half-spout formed into the tray surface. The steps to use this tray are about as efficient as is possible when the counting function is to be incrementally performed by the operator.

Counting pills with a machine-vision device incorporating a translucent pill surface is described in U.S. Pat. No. 6,610,973 for a “Pill Counting Aid Using a Planar Light Diffusing Panel for Receipt and Retention of the Pills” by the inventor of the present invention, the contents of which are incorporated herein by reference.

Counting pills with machine-vision device and a pill counting tray much like that described in U.S. Pat. No. 2,530,009 is described in prior art expired U.S. Pat. No. 6,738,723 for a “Pharmacy Pill Counting Vision System.” In addition, U.S. Pat. No. 6,738,723 describes the use of the displayed count produced by the machine-vision device as feedback to direct the operator to move pills between “first and second portions” of the tray surface, designated as counted and excess, until the desired count is displayed.

The convenience of using machine-vision to count pills is complicated by the relatively recent recognition that cross contamination of patient's prescriptions with even minute amounts of pill dust and residue can have very serious medical consequences for some patients. Currently available mechanical and machine-vision based pill counting machines with closed chutes or difficult-to-clean paths for counted pills thus have significant disadvantages.

### BRIEF SUMMARY OF THE DISCLOSURE

Embodiments of the invention comprise a tray for use in counting discrete items, such as pills, capsules, etc., and associated methods for counting such items. In one embodiment of the invention, a pill/capsule counting device comprises a horizontal planar counting surface, a spout or funnel for directing pills/capsules from the counting surface into a container, and a divider having a straight distal edge. The divider is selectively movable between a first position in which the distal edge is not in contact with the counting surface and a second position in which the distal edge is in contact with the counting surface. The divider is biased into the first position. In the second position, the divider divides the counting surface into first and second portions and retains any pills/capsules on the second portion of the counting surface. The first and second portions of the counting surface are level with each other.

The device may further comprise at least one containment wall projecting upward from at least one edge of the counting surface. The at least one containment wall may comprise a first wall, and the spout or funnel may be built into the first wall. The at least one containment wall may further comprise a second wall, and the divider may be hingedly affixed to the second wall. The second wall may be on an opposite side of the counting surface from the first wall.

The counting surface may comprise an indicia of demarcation between the first and second portions.

In an alternative embodiment of the invention, a method of dispensing a desired quantity of pills/capsules comprises: placing an undetermined quantity of pills/capsules from a first container onto a horizontal planar counting surface of a pill/capsule counting device, the counting surface comprising a first portion and a second portion that are level with each other; moving one or more pills/capsules from the first portion of the counting surface to the second portion of the counting surface and/or from the second portion of the counting surface to the first portion of the counting surface as needed until a quantity of pills/capsules on the first portion of the counting device equals the desired quantity of pills/capsules; moving a divider having a straight distal edge from a first position in which the distal edge is not in contact with the counting surface to a second position in which the distal edge is in contact with the counting surface, wherein the divider is biased into the first position, wherein in the second position the divider retains any pills/capsules on the second portion of the counting surface; and tilting the pill/capsule counting device to direct the pills/capsules on the first portion of the counting surface out through a spout or funnel and into a second container.

The method may further comprise releasing the divider to allow the divider to return to the first position; and tilting the pill/capsule counting device to direct the pills/capsules on the second portion of the counting surface out through the spout or funnel and into the first container.

The method may further comprise counting a quantity of pills/capsules on the first portion of the counting surface. The counting may be performed manually or by a machine-vision device. The method may further comprise counting a quantity of pills/capsules on the first portion of the counting surface after one or more pills/capsules have been moved from the first portion of the counting surface to the second portion of the counting surface and/or from the second portion of the counting surface to the first portion of the counting surface.

In another alternative embodiment of the invention, a pill/capsule counting system comprises a pill/capsule counting tray and a machine-vision device. The pill/capsule counting tray comprises a horizontal planar pill/capsule counting surface, a spout or funnel for directing pills/capsules from the counting surface into a container, and a divider having a straight distal edge. The divider is selectively movable between a first position in which the distal edge is not in contact with the counting surface and a second position in which the distal edge is in contact with the counting surface. the divider is biased into the first position. In the second position, the divider divides the counting surface into first and second portions and retains any pills/capsules on the second portion of the counting surface. The first and second portions of the counting surface are level with each other. The machine-vision device is arranged to count a quantity of pills/capsules on the first portion of the counting surface.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a drawing of the tray device of this invention.

FIG. 2 is a drawing of the tray device of this invention with a machine-vision pill counting device.

FIG. 3 through FIG. 7 are drawings showing various method steps of this invention.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention comprise a tray for use in counting discrete items, such as pills, capsules, etc., and associated methods for counting such items. Such items are referred to herein generally as pills, however the devices and methods of embodiments of the invention may be used to count any suitable items and are not limited to use for counting pills or capsules. Embodiments of the invention provide an easily cleaned pill counting tray such that the time and motion operations to use it are minimal, natural and efficient. The devices and methods of embodiments of the invention may be used in conjunction with machine-vision, as described herein, and such operations do not negate the efficiency improvements and fatigue reduction benefits of using machine-vision. The devices and methods of embodiments of the invention enable an accurate pill count to be verifiable by machine-vision just prior to the pouring of the pills into a target container.

The Tray Physical Device

This invention is optimized for use as described in U.S. Pat. No. 6,738,723, but without the trough/funnel for incrementally counted pills taught in U.S. Pat. No. 2,530,009 and with the addition of other critical functional features described herein.

The materials from which the device is made may be plastic, metal or other materials that meet safety requirements for contact with pills for human consumption. It is desirable that the materials chosen be light and strong, as the tray will be repeatedly lifted during its use and occasionally dropped accidentally.

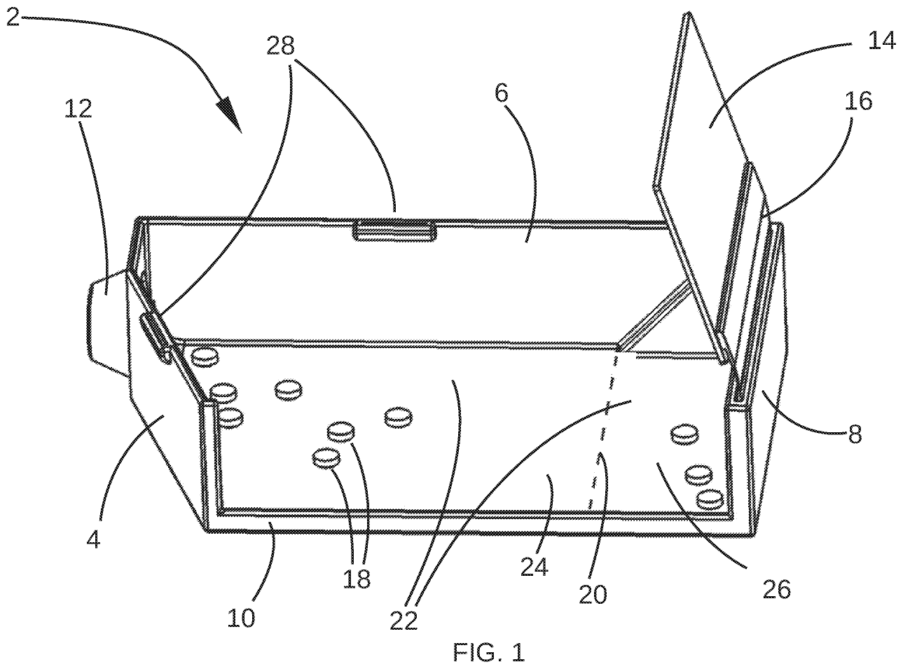

In FIG. 1, pill counting tray 2 comprises a flat tray surface 22 bordered by two relatively high containment side walls 4 and 6 which also serve as alternate support surfaces for pills 18 when tray 2 is tilted back and lightly shaken during the process of pouring pills 18 through built-in spout 12. The slanted angle of sidewall 4 and the intentional design of spout 12 to be an extension of side wall 6 cause them to act together as an effective funneling structure during that process. Containment side walls 4 and 6 should typically be a minimum of 1.5 inches in height to effectively serve their alternate function. Unlike conventional pill counting trays that have two spouts (one for directing pills into a dispensing container and one for directing pills back into a bulk or stock container), the pill counting tray of embodiments of the invention only needs to have one spout.

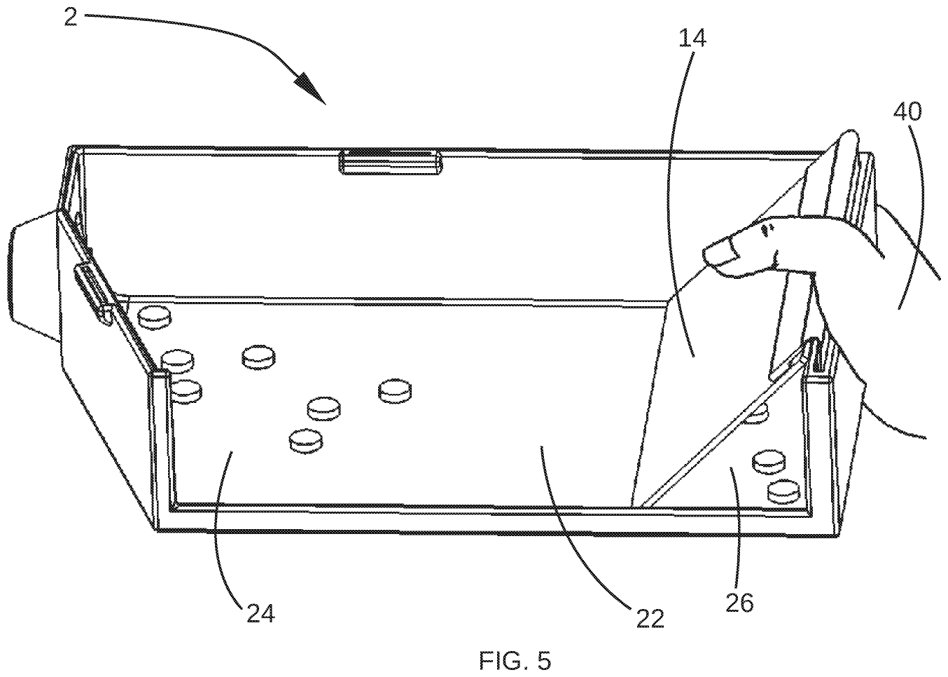

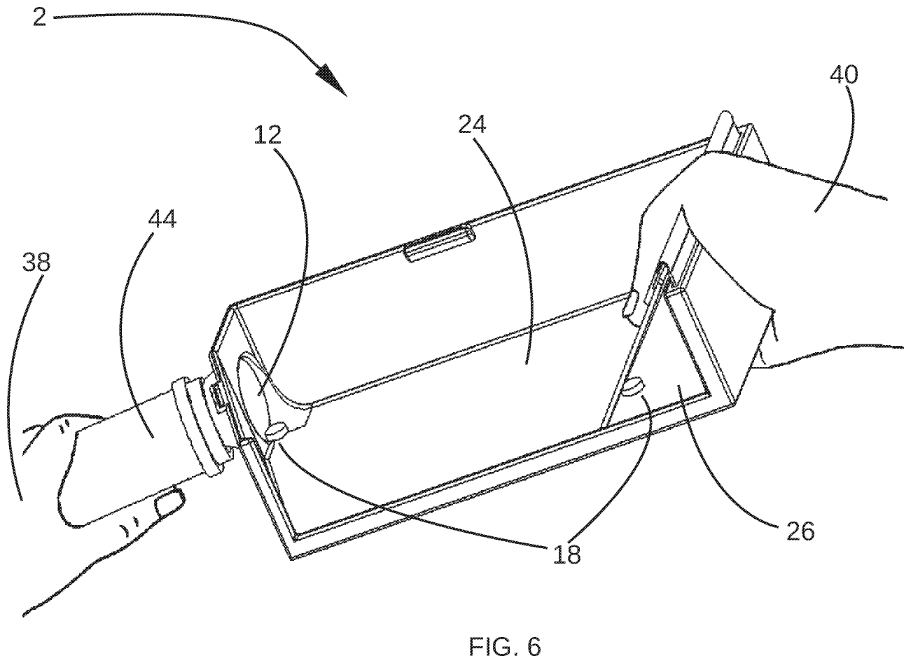

The height of front tray wall 10 is sufficient to stop rolling pills but low enough to allow the operator to use a conventional counting spatula to sort pills 18 on flat tray surface 22 to either the counted pill area 24 or the excess pill area 26. In one exemplary embodiment of the invention, the height of front tray wall 10 is about 0.25 inches. Excess pill area 26 is defined by the reach of excess pill-trapping flap 14 when in its depressed position (illustrated in FIGS. 5 and 6) as allowed by its flat spring attachment hinge 16.

Flat spring attachment hinge 16 connects pill-trapping flap 14 to the top of containment side wall 8. Flap 14 is preferably clear, rigid, and lightly sprung by hinge 16 to normally rest in the upright position shown in FIGS. 1-4 and 7, thus not interfering with the view of tray surface 22 by the operator nor by any optional overhead machine-vision camera.

Dividing line 20 between counted pill area 24 and excess pill area 26 may be demarcated as a visible feature of the tray surface and/or by markings on a camera image display of a machine-vision counter. Importantly, there is no height difference or other physical barrier between the counted pill area 24 and the excess pill area 26 to enable the operator to easily move pills from the counted pill area 24 to the excess pill area 26 and vice versa. If there is a visible demarcation between counted pill area 24 and excess pill area 26 on the tray surface 22, such a visible demarcation would typically be a printed line (or the like) having no or negligible height so as to enable the operator to easily move pills from the counted pill area 24 to the excess pill area 26 and vice versa

Hinge 16 is preferably made from a commercially available plastic strip hinge with a natural spring tendency against flexure. Flap 14 is optimally of a hard, uncolored transparent plastic. Being able to visually see any pills that may be caught under the edge of flap 14 is convenient for efficient operation.

When used in conjunction with the machine-vision pill counter as described in U.S. Pat. No. 6,610,973 by the inventor of the present invention, tray surface 22 of tray 2 preferably should be a light transmitting material to facilitate backlit operation. Optional camera registration features 28 allow software location of the tray 2 position if needed. Optional camera registration features 28 would typically comprise one or more small, indelible, precisely formed marks or features incorporated into the tray which; visually contrast in color or reflectance from the tray material; have sharp visual edge definition to facilitate their location and orientation by software in images captured by the camera; and are not located where pills could cover them.

The Tray Usage Method

The relatively few time and motion steps that are the primary objective of this invention are described below. The use of the terms left hand and right hand are merely for convenience and are based on the specific structural arrangement illustrated (i.e., spout 12 on the left of the device and flap 14 on the right of the device), and do not reflect some options available to the operator. A left/right mirror-image manufacture of the tray device of FIG. 1 is both possible and reasonable.

Although the method described herein is optimized for machine-vision augmented counting, it can be used without this assistance. In that case, each operator will count the pills according to his/her individual grouping preferences that are not described herein.

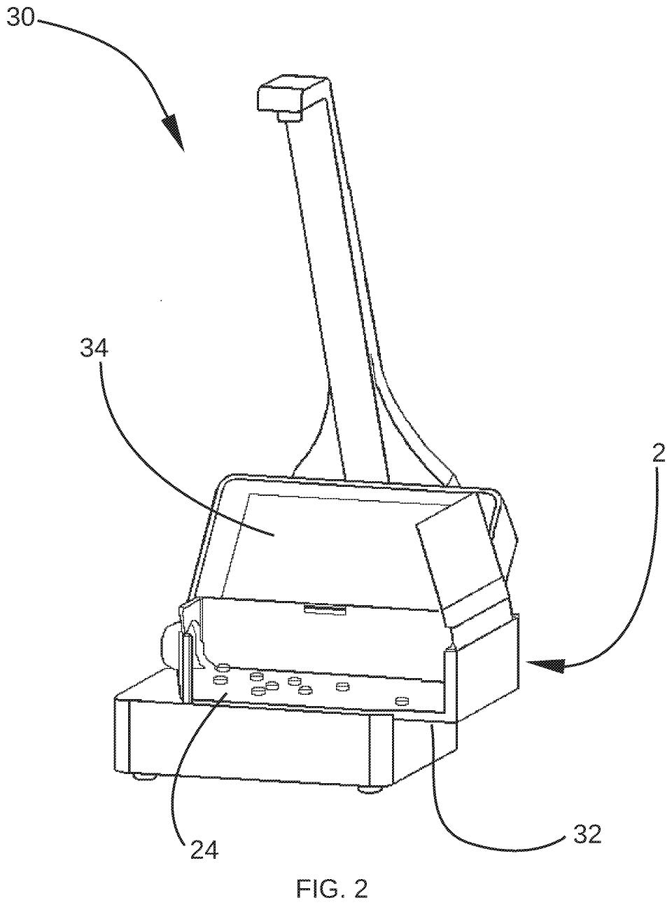

FIG. 2 shows the tray 2 in its place on machine-vision counter 30, elevated with an overhang 32 for the operator's fingers to fit beneath the tray 2 when it is picked up. (If tray 2 is used alone, it could be elevated on a flat, level object for the same advantage. Alternatively, a notch or the like (not illustrated) may be defined in containment side wall 8 for receiving the operator's fingers when the tray 2 is picked up.) In this position the relevant tray surfaces can easily be wiped clean at the discretion of the operator. Machine-vision counter display 34 is the presumed location of the continuously updated count of the pills in counted pill area 24. The base of the machine-vision counter 30 may provide the backlight for the tray surface 22 (the illustrated overhang does not affect this backlighting as the excess pill area 26 need not be backlit). The camera field of view of the machine-vision counter 30 is typically larger than the pill counting area 24. The operating software of the machine-vision counter 30 uses the registration features 28 to determine when the tray is properly justified in its holder and to identify the counted pill area 24 and the excess pill area 26 (and typically also identify a narrow strip surrounding the flap contact line which constitutes where pills must not be when the flap is depressed by the operator's thumb. This strip separates the counted pill area 24 and the excess pill area 26. The strip need not be physically indicated on the tray surface as it may be graphically indicated on the real-time display 34.

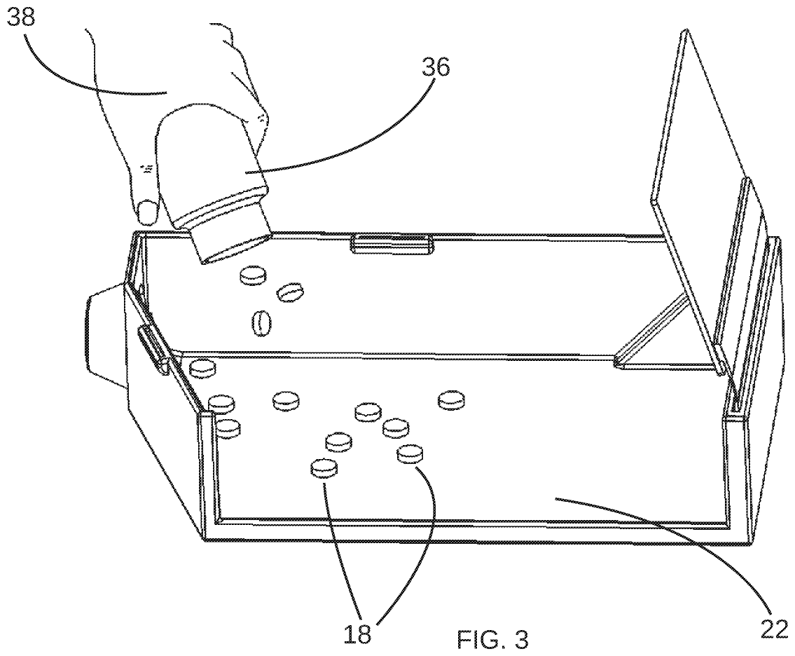

FIG. 3 shows the operator pouring pills 18 from the bulk pill supply bottle 36 held by the operator's left hand 38 onto tray surface 22 to match or exceed the desired count, using feedback from an out-of-view machine-vision display if present.

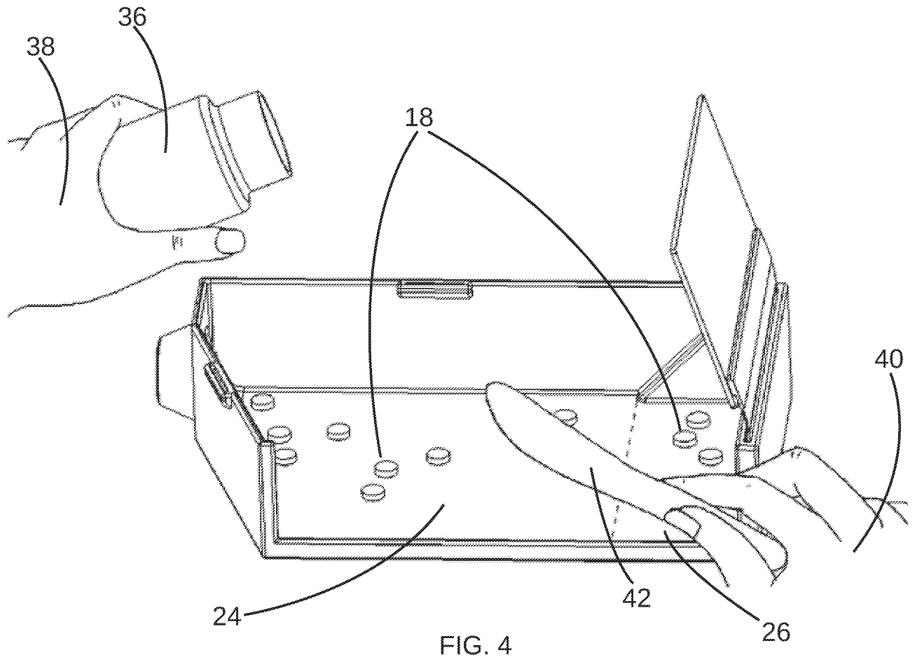

FIG. 4 shows the operator moving pills 18 back and forth between counted pill area 24 and excess pill area 26 as needed with spatula 42 held with the operator's right hand 40, using feedback from an out-of-view machine-vision display if present.

The operations of FIG. 3 and FIG. 4 are repeated until the desired count is achieved in counted pill area 24, during which the operator typically continuously holds the bulk pill supply bottle 36 with the left hand 38 and spatula 42 in the right hand 40 (although, the operator does not necessarily have to continuously hold the bulk pill supply bottle 36).

When the desired count is achieved in counted pill area 24, the operator puts down the bulk pill supply bottle 36 and spatula 42 and grips tray 2 with the right hand 40 as shown in FIG. 5, with the operator's thumb pressing excess pill-trapping flap 14 down to tray surface 22 and trapping any excess pills in excess pill area 26.

FIG. 6 shows the operator holding patient vial 44 with the left hand 38 such that the open top end of patient vial 44 aligns with tray funnel 12 and tilting tray 2 with the right hand 40 while tilting patient vial 44 with the left hand 38 to pour the pills 18 from counted pill area 24 into patient vial 44 while holding back other pills 18 trapped in excess pill area 26.

Operator then puts down patient vial 44 with the left hand 38 and picks up the bulk pill supply bottle 36 with the left hand 38.

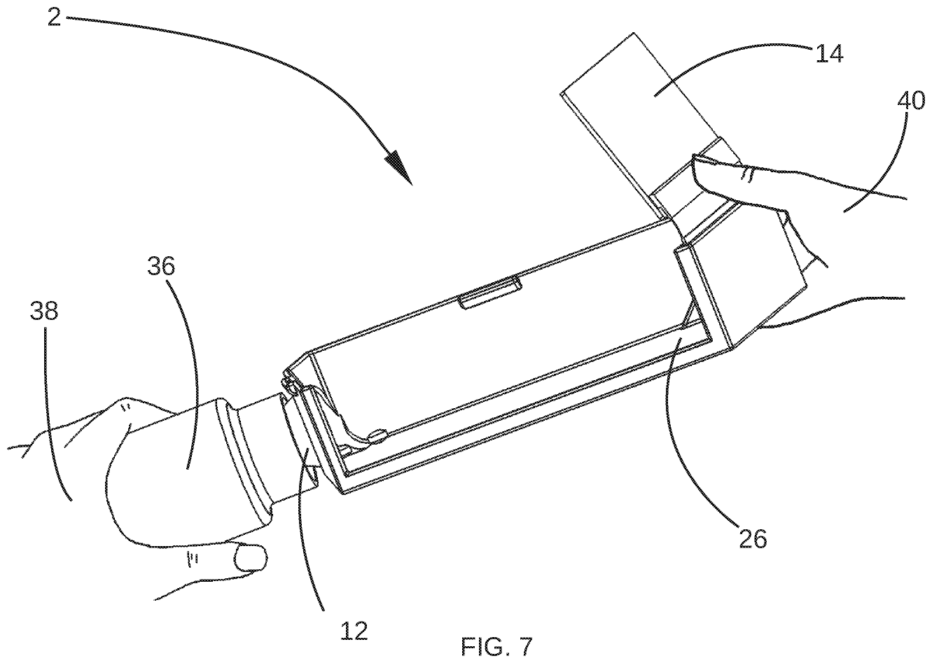

FIG. 7 shows the operator holding bulk pill supply bottle 36 with the left hand 38 such that the open top end of bulk pill supply bottle 36 is aligned with tray funnel 12 and tilting tray 2 and bulk pill supply bottle 36 together to pour the pills from excess pill area 26 into bulk pill supply bottle 36, raising the thumb of right hand 40 to release excess pill-trapping flap 14 to an upright position.

Operator puts down bulk bottle and tray and the operation is complete.

The terminology used herein is for the purpose of describing particular embodiments only and is not intended to be limiting of the invention. Unless specifically set forth herein, the terms “a,” “an” and “the” are not limited to one element, but instead should be read as meaning “at least one.” The terminology includes the words noted above, derivatives thereof and words of similar import. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A pill/capsule counting device comprising:
a horizontal planar counting surface;
a spout or funnel for directing pills/capsules from the counting surface into a container; and
a divider having a straight distal edge, wherein the divider is selectively movable between a first position in which the distal edge is not in contact with the counting surface and a second position in which the distal edge is in contact with the counting surface, wherein the divider is biased into the first position, wherein in the second position the divider divides the counting surface into first and second portions and retains any pills/capsules on the second portion of the counting surface, wherein the first and second portions of the counting surface are level with each other.

2. The device of claim 1, further comprising at least one containment wall projecting upward from at least one edge of the counting surface.

3. The device of claim 2, wherein the at least one containment wall comprises a first wall; and
wherein the spout or funnel is built into the first wall.

4. The device of claim 3, wherein the at least one containment wall further comprises a second wall; and
wherein the divider is hingedly affixed to the second wall.

5. The device of claim 4, wherein the second wall is on an opposite side of the counting surface from the first wall.

6. The device of claim 1, wherein the counting surface comprises an indicia of demarcation between the first and second portions.

7. A method of dispensing a desired quantity of pills/capsules, the method comprising:
placing an undetermined quantity of pills/capsules from a first container onto a horizontal planar counting surface of a pill/capsule counting device, the counting surface comprising a first portion and a second portion that are level with each other;
moving one or more pills/capsules from the first portion of the counting surface to the second portion of the counting surface and/or from the second portion of the counting surface to the first portion of the counting surface as needed until a quantity of pills/capsules on the first portion of the counting device equals the desired quantity of pills/capsules;
moving a divider having a straight distal edge from a first position in which the distal edge is not in contact with the counting surface to a second position in which the distal edge is in contact with the counting surface, wherein the divider is biased into the first position, wherein in the second position the divider retains any pills/capsules on the second portion of the counting surface; and
tilting the pill/capsule counting device to direct the pills/capsules on the first portion of the counting surface out through a spout or funnel and into a second container.

8. The method of claim 7, further comprising:
releasing the divider to allow the divider to return to the first position; and
tilting the pill/capsule counting device to direct the pills/capsules on the second portion of the counting surface out through the spout or funnel and into the first container.

9. The method of claim 7, further comprising counting a quantity of pills/capsules on the first portion of the counting surface.

10. The method of claim 9, wherein the counting is performed manually or by a machine-vision device.

11. The method of claim 9, further comprising counting a quantity of pills/capsules on the first portion of the counting surface after one or more pills/capsules have been moved from the first portion of the counting surface to the second portion of the counting surface and/or from the second portion of the counting surface to the first portion of the counting surface.

12. A pill/capsule counting system comprising:
a pill/capsule counting tray comprising:
a horizontal planar pill/capsule counting surface;
a spout or funnel for directing pills/capsules from the counting surface into a container; and
a divider having a straight distal edge, wherein the divider is selectively movable between a first position in which the distal edge is not in contact with the counting surface and a second position in which the distal edge is in contact with the counting surface, wherein the divider is biased into the first position, wherein in the second position the divider divides the counting surface into first and second portions and retains any pills/capsules on the second portion of the counting surface, wherein the first and second portions of the counting surface are level with each other; and
a machine-vision device arranged to count a quantity of pills/capsules on the first portion of the counting surface.

13. The system of claim 12, further comprising at least one containment wall projecting upward from at least one edge of the counting surface.

14. The system of claim 13, wherein the at least one containment wall comprises a first wall; and
wherein the spout or funnel is built into the first wall.

15. The system of claim 14, wherein the at least one containment wall further comprises a second wall; and
wherein the divider is hingedly affixed to the second wall.

16. The system of claim 15, wherein the second wall is on an opposite side of the counting surface from the first wall.

17. The system of claim 12, wherein the counting surface comprises an indicia of demarcation between the first and second portions.
